(19) United States
(12) Patent Application Publication
(10) Pub. No.: US 2025/0303423 A1
(43) Pub. Date: Oct. 2, 2025

(54) MAGNETIC PARTICLE SEPARATION SYSTEM AND METHOD OF PERFORMING MAGNETIC SEPARATION

(71) Applicant: Honeybee Robotics, LLC, Longmont, CO (US)

(72) Inventors: Damian Hackett, Washington, DC (US); Nicklaus W. Traeden, Cuyahoga Falls, OH (US); Kathryn Faye Bywaters, Monrovia, CA (US); Kris Zacny, Altadena, CA (US); Peter Pulai, Los Angeles, CA (US)

(21) Appl. No.: 19/083,584

(22) Filed: Mar. 19, 2025

Related U.S. Application Data
(60) Provisional application No. 63/571,621, filed on Mar. 29, 2024.

(51) Int. Cl. B03C 1/28; B03C 1/033; G01N 1/40

(52) U.S. Cl. CPC B03C 1/288; B03C 1/0332; B03C 1/0335; G01N 1/4077; B03C 2201/18

(57) ABSTRACT

A magnetic sample extraction system includes a stand frame; a container selectively positioned within the stand frame and configured to store a predetermined quantity of a liquid solution; a first magnetic member provided adjacent to the container; and a second magnetic member provided adjacent to the container and the first magnetic member. The second magnetic member is an electromagnet configured to be cycled between an on state and an off state at a predetermined frequency. The first magnetic member and the second magnetic member form alternating magnetic fields to separate magnetic particles from rocky particles within a sample.

### CROSS-REFERENCE TO RELATED APPLICATIONS

This application claims priority to U.S. Provisional Application No. 63/571,621, filed on Mar. 29, 2024, all of which are incorporated herein by reference in their entireties.

### BACKGROUND

The subject matter disclosed herein relates in general to systems and methods for separating magnetic particles from a solution.

Recently, space exploration has included reaching and landing on extraterrestrial worlds (e.g., planets, moons, etc.). Equipment brought to these worlds sometimes includes instruments for extracting and storing samples such as terrain samples, rock samples, and other regolith material. In some instances, it is desirable to obtain certain materials from within the overburden or target sample. Typical terrestrial separation systems include using centrifuges or chemical reactants. In the case of centrifugation, the sample suspended in solution is rotated about an axis. Under the centripetal loading, materials of different densities will separate with the most dense materials flowing to the radially outer most surface of the sample container.

While existing separation methods are suitable for their intended purposes the need for improvement remains, particularly in methods and systems for separating magnetic particles having the features described herein.

### BRIEF DESCRIPTION

According to one aspect of the present disclosure, a magnetic sample extraction system is provided. The magnetic sample extraction system may include a stand frame a container selectively positioned within the stand frame, the container being configured to store a predetermined quantity of a liquid solution, a first magnetic member provided adjacent to the container, and a second magnetic member provided adjacent to the container and the first magnetic member. The second magnetic member may be an electromagnet configured to be cycled between an on state and an off state at a predetermined frequency.

According to another aspect of the present disclosure, a method of operating a magnetic separation system to separate magnetic material from a sample within a liquid solution is provided. The system may include a container, a lid, and a first magnetic member. The method may include supplying a predetermined quantity of the liquid solution to the container, supplying the sample to the liquid solution within the container, activating the first magnetic member attached to the stand at a predetermined frequency for a predetermined length of time after supplying the liquid solution and the sample to the container, performing an agitation cycle to the container after the predetermined length of time, and separating the lid from the container after performing the agitation cycle. The magnetic material may be posited on the lid.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 provides a perspective view of a magnetic sample extraction system according to exemplary embodiments of the present disclosure.

FIG. 2 provides a close-up perspective view of the exemplary magnetic sample extraction system of FIG. 1.

FIG. 3 provides a flow chart illustrating a method of operating a magnetic sample separation system according to exemplary embodiments of the present disclosure.

### DETAILED DESCRIPTION

Embodiments disclosed herein provide for systems and methods for determining an amount of overburden material collected with an extraterrestrial sample, particularly by separating out magnetic material such as nano-phase iron particles. Extraterrestrial environments (e.g., planets, moons, etc.) are typically subject to bombardment from celestial objects, such as meteors, comets, space dust, and the like. Such bombardments can leave coatings, or overburden as a layer on the surface of the extraterrestrial environment. In some cases, this overburden is not native to the world itself.

Embodiments described herein include novel methods for extracting magnetic materials material from collected samples to determine a percentage or amount of collected overburden. For instance, a combination of selective magnetism, permanent magnetism, and agitation may be utilized to separate the nano-phase iron particles from rocky sample material. It should be appreciated that in some embodiments, the sample will be acquired by drilling into a target surface. The drilling operation results in a powdery volume of material that is comprised of a plurality of compounds and elements. Accordingly, while embodiments herein may refer to a “rocky” sample, this sample may in some instances be a fine powder material.

Historically, methods such as centrifuging have been used to separate non-homogenous mixtures. For instance, collected samples may need to be transported to a laboratory to be properly separated and analyzed. Further centrifugation equipment may be heavy and difficult to transport to the environment where the samples are acquired. Additionally, chemical reactants have been added to samples to measure or determine makeup of mixtures. Similarly, the addition of extra reactants and required reactions may add unnecessary steps to the procedure. In contrast, embodiments of the present disclosure provide methods of magnetically separating iron particles from rocky materials within a solution (e.g., an alcoholic solution).

Turning now to the figures, a magnetic sample extraction system 100 will be described in detail. System 100 may be a standalone system. In another embodiment, the system 100 may be integrated with a sample collection system (e.g. a drilling system). For instance, system 100 may be configured to receive a sample (e.g., a terrain sample, a rocky sample, a soil sample, etc.) therein. According to at least some embodiments, system 10 may define an axial direction A, a radial direction R, and a circumferential direction C. It should be understood that the coordinate system described herein is provided by way of example only and that system 100 may be incorporated into any suitable coordinate system.

It should be appreciated that while embodiments herein describe the use of the system 100 with “samples,” this is not intended to indicate a particular size, volume, or weight of the material being analyzed. In other embodiments, the system 100 may be scaled, to separate larger volumes of acquired material (e.g. iron) to allow for the use of in situ materials in extraterrestrial operations (e.g. to fabricate steel).

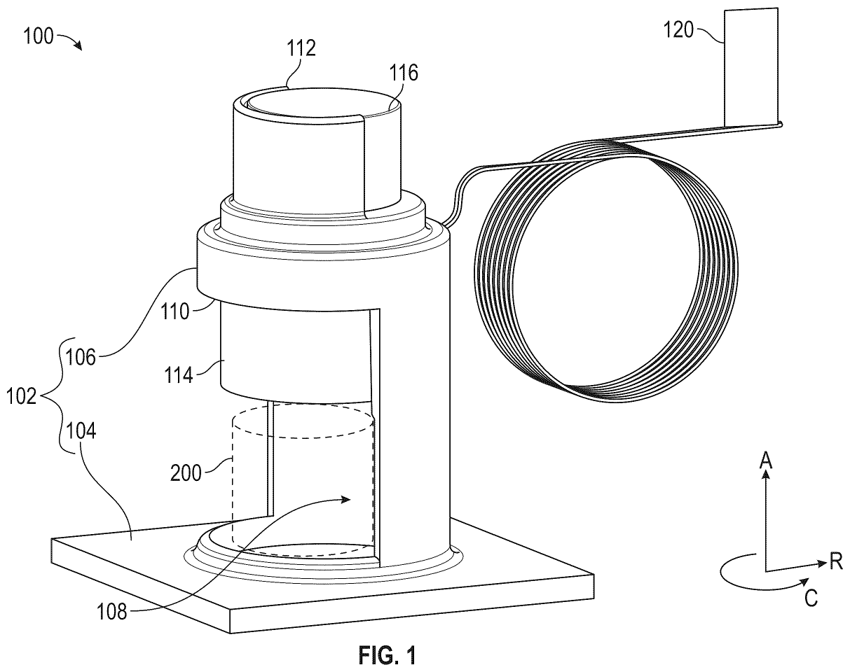

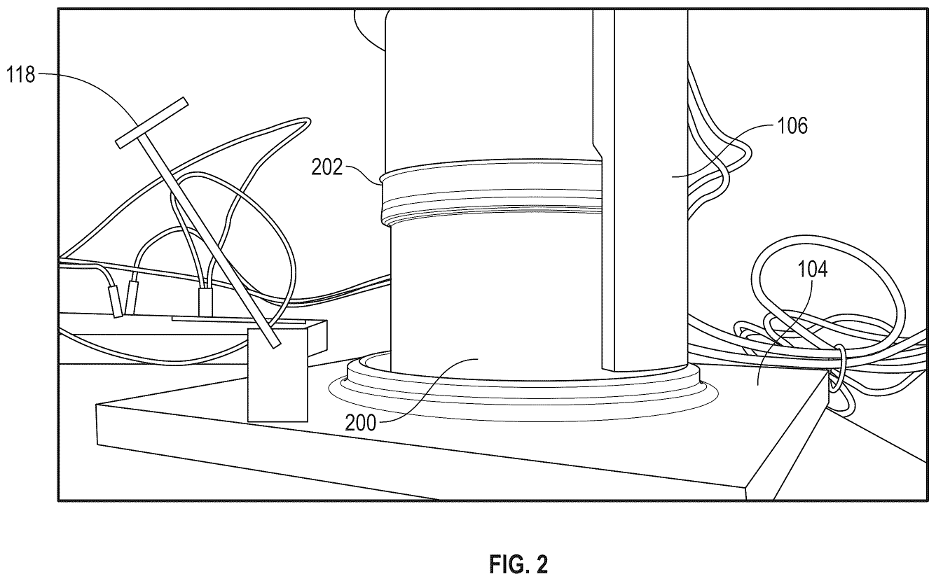

Referring now to FIGS. 1 and 2, system 100 may include a stand frame 102. Stand frame 102 may include a base portion 104 and a tower portion 106. Tower portion 106 may extend from base portion 104 along the axial direction A. Base portion 104 may be predominantly plate-shaped. For instance, base portion 104 may be configured to receive a container 200 (described below) thereon. According to at least some embodiments, container 200 is selectively received within a portion of tower portion 106. Accordingly, tower portion 106 may define a container receiving opening 108. In detail, at least a portion of a wall of tower portion 106 may be removed or open to define a slot or recess that allows container 200 to be inserted therein (e.g., along the radial direction R).

Stand frame 102 may include a first magnet receiving portion 110. First magnet receiving portion 110 may be positioned above container receiving opening 108 (e.g., along the axial direction A). First magnet receiving portion 110 may include one or more brackets or securing members configured to hold or secure, for instance, a magnetic member therein. First magnetic receiving portion 110 may be at least partially formed within tower portion 106.

Stand frame 102 may include a second magnetic receiving portion 112. Second magnetic receiving portion 112 may be positioned above first magnetic receiving portion 110 (e.g., along the axial direction A). Second magnet receiving portion 112 may include one or more brackets or securing members configured to hold or secure, for instance, a magnetic member therein. Second magnetic receiving portion 112 may be at least partially formed within tower portion 106.

System 100 may include a container (e.g., container 200). Container 200 may be selectively received or positioned within stand frame 102, as mentioned above. Container 200 may be configured to store a predetermined quantity of a liquid solution. As would be understood, container 200 may be or include any suitable liquid tight receptacle, vessel, or storage member capable of holding a liquid therein. It is hereby noted that containers are known in the art and as such a detailed description will be foregone for the sake of brevity.

As mentioned, container 200 may store a liquid solution. According to some embodiments, the liquid solution is an isopropyl alcohol solution. For instance, the liquid solution may be a 99% by volume isopropyl alcohol solution. However, the solution contained within container 200 may vary according to specific embodiments and the disclosure is not limited to the examples provided herein. Additionally or alternatively, container 200 may include a removable lid 202 (FIG. 2). For instance, lid 202 may be removably coupled to container 200. As will be described below, lid 202 may be coupled to container 200 during an operation of system 100.

System 100 may include a first magnetic member 114. First magnetic member 114 may be provided or positioned adjacent to container 200. For instance, first magnetic member 114 may be selectively received within first magnetic receiving portion 110 of stand frame 102. First magnetic member 114 may be configured to generate a magnetic field. According to at least some embodiments, first magnetic member 114 is configured to selectively generate the magnetic field based on one or more inputs.

First magnetic member 114 may be or include an electromagnet. In detail, first magnetic member 114 may be configured to selectively activate to generate the magnetic field based on an electric input thereto (e.g., from a power source). Thus, first magnetic member 114 may be cycled between an on state and an off state. In some instances, first magnetic member 114 may be cycled between the on state and the off state according to a predetermined frequency. The predetermined frequency may vary according to specific embodiments. For at least one example, the predetermined frequency is between about 2 Hertz (Hz) and about 5 Hz. As will be described in further detail below, the predetermine frequency may cause first magnetic member 114 to supply the cycling magnetic field to the container 200.

First magnetic member 114 may be a direct current electromagnet. Additionally or alternatively, first magnetic member 114 may be a first predetermined magnetic force. According to at least some embodiments, the first predetermined magnetic force is between about 170 pounds-force (lbf) and about 190 lbf. It should be noted that the ranges describe herein are provided by way of example only and that first magnetic member 114 may be configured to produce or generate any suitable magnetic force.

System 100 may include a second magnetic member 116. Second magnetic member 116 may be provided or positioned adjacent to container 200. For instance, second magnetic member 116 may be selectively received within second magnetic receiving portion 110. Second magnetic member 116 may be configured to produce, generate, or otherwise emit a magnetic field. According to at least some embodiments, second magnetic member 116 is a solid state magnet.

Additionally or alternatively, second magnetic member 116 may be a neodymium magnet having a second predetermined magnetic force. For instance, the second predetermined magnetic force may be between about 140 lbf and about 160 lbf. It should be noted that the ranges described herein are provided by way of example only and that second predetermined magnetic force may be any suitable force. Additionally or alternatively, second magnetic member 116 may provide the magnetic force to container 200.

Second magnetic member 116 may be positioned axially adjacent/above first magnetic member 114 (e.g., along the axial direction A). Additionally or alternatively, second magnetic member 116 may be configured to interact collectively with first magnetic member 114. As mentioned, first magnetic member 114 may provide the cycling magnetic force while second magnetic member 116 provides a steady state magnetic force.

First magnetic member 114 may produce the first predetermined magnetic force along a first direction. Thus, second magnetic member 116 may produce the second predetermined magnetic force along a second direction opposite from the first direction. Additionally or alternatively, first magnetic member 114 and second magnetic member 116 may be aligned with each other along the axial direction A. As will be described, the collected sample within the liquid solution may thus be subjected to alternating magnetic forces to generate a periodic, aperiodic, or pulsating movement within the liquid solution.

System 100 may include a percussive member 118. Percussive member 118 may be operably coupled with stand frame 102. Additionally or alternatively, percussive member 118 may be configured to selectively contact container 200 according to one or more inputs. For instance, percussive member 118 may provide one or more percussive inputs to container 200 to perform an agitation to the liquid solution therein. Percussive member 118 may be referred to as a “thwacker” for instance, which is hereby noted as a term of the art. For instance, percussive member 118 may be or include a spring loaded mallet. In some instances, percussive member 118 is operated by a motor assembly to provide the repeated percussive inputs to container. It should be appreciated that other percussive devices may be used, such as but not limited to piezoelectric devices for example. In still further embodiments, the percussive force may be manually performed by an operator.

System 100 may include a controller 120, such as a microcontroller. Controller 120 may be generally configured to facilitate one or more operations of system 100. In this regard, first magnetic member 114 may be in communication with controller 120 such that controller 120 may communicate signals (e.g., control signals, inputs, etc.) to first magnetic member 114. First magnetic member 114 and other components of system 100 may be in communication with controller 120 via, for example, one or more signal lines or shared communication busses. In this manner, Input/Output (“I/O”) signals may be routed between controller 120 and various operational components of system 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of system 100. In this regard, the instructions may be software or any set of instructions that when executed by the processing device, cause the processing device to perform operations, such as running one or more software applications, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120.

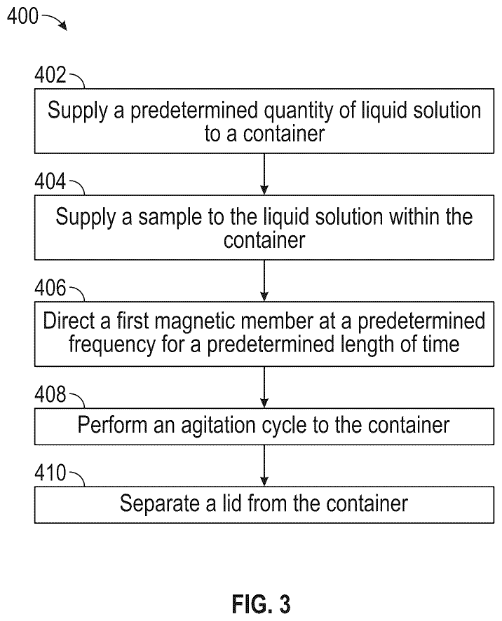

Now that the general descriptions of an exemplary magnetic sample extraction system have been described in detail, a method 400 of operating magnetic sample extraction system (e.g., system 100) will be described in detail. Although the discussion below refers to the exemplary method 400 of operating system 100, one skilled in the art will appreciate that the exemplary method 400 is applicable to any suitable system capable of separating magnetic particles and elements from rocky samples. In exemplary embodiments, the various method steps as disclosed herein may be performed by controller 120 and/or a separate, dedicated controller. Hereinafter, method 400 will be described with specific reference to FIG. 3.

At 402, method 400 may include supplying a predetermined quantity of liquid solution to a container. As mentioned, a container (e.g., container 200) may be configured to hold, store, or otherwise contain a fluid such as a liquid solution. The liquid solution may be an isopropyl alcohol solution at a predetermined volume ratio (e.g., 99%). In some instances, the liquid solution may be added to the container automatically, such as by a spigot or spout or the like. In additional or alternative embodiments, the liquid solution is added to the container manually (e.g., by a user).

At 404, method 400 may include supplying a sample to the liquid solution within the container. In detail, the sample may be a collected sample from an extraterrestrial body or world, such as a planet, a moon, an asteroid, or the like. The collected sample may be a predominantly rocky sample from a terrain or surface of the extraterrestrial body. The collected sample may additionally or alternatively include magnetic particles, such as nano-phase iron particles as a part of overburden or dusty surface coverings. It should be noted that the collected sample may be supplied to the container before the addition of the liquid solution, and the disclosure is not limited to the order described herein.

At 406, method 400 may include activating a first magnetic member at a predetermined frequency for a predetermined length of time. For instance, after supplying the sample to the liquid solution (or supplying the liquid solution to the sample), the first magnetic member (e.g., first magnetic member 114) may be driven at a predetermined frequency. As mentioned above, the first magnetic member may be an electromagnet configured to selectively produce a magnetic field at a given frequency. Accordingly, a power supply may be driven at a predetermined power level to generate the magnetic field at the predetermined frequency. According to some embodiments, the predetermined frequency is between about 2 Hz and about 5 Hz.

The first magnetic member may be driven for a predetermined amount or length of time. For instance, the predetermined length of time may be between about 2 minutes and about 4 minutes. However, it should be noted that the ranges described herein are provided by way of example only and that the first magnetic member may be driven at any suitable frequency for any suitable length of time to separate the magnetic particles from the sample. According to the predetermined frequency, the first magnetic member may be cycled between an on state and an off state. The cycling between the on state and off state may be on a predetermined periodic or aperiodic basis. Thus, the magnetic field applied to the container (e.g., to the liquid solution/sample mixture) may cycle such that the magnetic particles within the liquid solution are motivated or stirred apart from a remaining substance of the sample (e.g., rocky material).

According to some embodiments, the system includes a second magnetic member (e.g., second magnetic member 116). The second magnetic member may be a permanent magnet, such as a neodymium magnet. The second magnetic member may be positioned axially aligned with the first magnetic member. As would be understood, the second magnetic member may apply a constant magnetic field to the liquid solution/sample mixture. The constant magnetic field (e.g. polarity) may be opposite to the cyclic magnetic field generated by the first magnetic member. Accordingly, when the first magnetic member is in the on state, the magnetic particles may be urged or moved in a first direction, and when the first magnetic member is in the off state, the magnetic particles may be urged or moved in a second direction opposite the first direction.

At 408, method 400 may include performing an agitation cycle to the container. In detail, at the expiration of the predetermined length of time, the container (with the liquid solution/sample mixture) may be agitated. The agitation cycle may be performed manually, such as by a user physically shaking or stirring the container. In some instances, the agitation cycle is performed automatically, such as by a percussive member (e.g., percussive member 118). Additionally or alternatively, the system may include a vibrational element configured to vibrate the container. In response to each of the directing the first magnetic member at the predetermined frequency and performing the agitation cycle, the magnetic particles (e.g., nano-phase iron particles) may be urged toward a cap or lid of the container, such as by the second magnetic member (e.g., the permanent magnet).

At 410, method 400 may include separating the lid from the container after performing the agitation cycle. As mentioned, the magnetic particles may be urged toward the lid as a result of the cyclic magnetic field and the agitation cycle. Advantageously, an amount or percentage of magnetic particles may be analyzed to determine an amount of overburden collected as the sample.

The detailed description explains embodiments of the disclosure, together with advantages and features, by way of example with reference to the drawings.

The term “about” is intended to include the degree of error associated with measurement of the particular quantity based upon the equipment available at the time of filing the application.

It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description but is only limited by the scope of the appended claims.

What is claimed is:

1. A magnetic sample extraction system comprising:
a stand frame;
a container selectively positioned within the stand frame, the container being configured to store a predetermined quantity of a liquid solution;
a first magnetic member provided adjacent to the container; and
a second magnetic member provided adjacent to the container and the first magnetic member, wherein the second magnetic member is an electromagnet configured to be cycled between an on state and an off state at a predetermined frequency.

2. The magnetic sample extraction system of claim 1, wherein the first magnetic member is a neodymium magnet having a first predetermined magnetic force.

3. The magnetic sample extraction system of claim 2, wherein the first predetermined magnetic force is between 140 pounds-force (lbf) and 160 lbf.

4. The magnetic sample extraction system of claim 1, wherein the second magnetic member is a direct current electromagnet having a second predetermined magnetic force.

5. The magnetic sample extraction system of claim 4, wherein the second predetermined magnetic force is between 170 lbf and 190 lbf.

6. The magnetic sample extraction system of claim 1, wherein the predetermined frequency is between 2 Hertz (Hz) and 5 Hz.

7. The magnetic sample extraction system of claim 1, wherein the liquid solution comprises an isopropyl alcohol solution at a predetermined volume ratio percentage.

8. The magnetic sample extraction system of claim 7, wherein the predetermined volume ratio percentage is 99%.

9. The magnetic sample extraction system of claim 1, further comprising:
a percussive member operably coupled with the container and configured to selectively provide a percussive input to the container; and
a controller operably coupled with the second magnetic member, wherein the controller is configured to perform an operation, the operation comprising:
driving the second magnetic member at the predetermined frequency for a predetermined length of time; and
ceasing the driving of the second magnetic member after the predetermined length of time, wherein the predetermined length of time is between 1 minute and 3 minutes.

10. The magnetic sample extraction system of claim 9, wherein the percussive member is a spring loaded mallet.

11. A method of operating a magnetic separation system to separate magnetic material from a sample within a liquid solution, the system comprising a container, a lid, and a first magnetic member, the method comprising:
supplying a predetermined quantity of the liquid solution to the container;
supplying the sample to the liquid solution within the container;
activating the first magnetic member attached to the stand at a predetermined frequency for a predetermined length of time after supplying the liquid solution and the sample to the container;
performing an agitation cycle to the container after the predetermined length of time; and
separating the lid from the container after performing the agitation cycle, wherein the magnetic material is posited on the lid.

12. The method of claim 11, wherein the first magnetic member is an electromagnetic member configured to be cycled between an on state and an off state at the predetermined frequency.

13. The method of claim 12, wherein the predetermined frequency is between 2 Hz and 5 Hz.

14. The method of claim 12, wherein the first magnetic element has a first predetermined magnetic force of between 170 lbf and 190 lbf.

15. The method of claim 11, wherein the system further comprises:
a second magnetic member attached to the stand, the second magnetic member being a solid state magnetic member.

16. The method of claim 15, wherein the second magnetic element has a second predetermined magnetic force of between 140 lbf and 160 lbf.

17. The method of claim 11, wherein the liquid solution comprises an isopropyl alcohol solution at a predetermined volume ratio percentage.

18. The method of claim 17, wherein the predetermined volume ratio percentage is 99%.

19. The method of claim 11, wherein the system further comprises:
a percussive element operably coupled to the stand and configured to selectively provide a percussive input to the container.

20. The method of claim 11, wherein performing the agitation cycle comprises:
directing the percussive element to provide the percussive input to the container a predetermined number of times.
